(19) United States
(12) Patent Application Publication
(10) Pub. No.: US 2007/0022221 A1
(43) Pub. Date: Jan. 25, 2007

(54) Programmable control device

(75) Inventors: Yuan-Cheng Chen, Jhubei City (TW); Thomas Ma, Beijing (CN); Chuanguo Ji, Shin County (CN)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/291,767

(22) Filed: Dec. 2, 2005

(30) Foreign Application Priority Data
Jul. 5, 2005 (TW) 094122676

(51) Int. Cl. G06F 3/00

(52) U.S. Cl. 710/8

(57) ABSTRACT

A programmable control device includes an input unit, a memory unit, an execution unit, a monitor unit and an output unit. The input unit has at least one input terminal for receiving an input signal. The memory unit defines plural feature tables for corresponding functional units, the feature table defining a state of the functional unit and an event to be executed according to an input signal corresponding to the state. The execution unit executes an event corresponding to the functional unit triggered by an input signal, and thus produces a driving signal and/or an output signal. The monitor unit monitors the execution unit to trigger a corresponding functional unit and to use the driving signal as an input signal for the functional unit to execute a corresponding event. The output unit has at least one terminal to output the output signal.

### BACKGROUND OF THE INVENTION

1. Field of the Invention

The invention relates to a system for developing a control device and, more particularly, to a programmable control device.

2. Description of Related Art

In general, control devices, such as single-chips or embedded control chips, carry out their functions by executing the stored control programs therein. Typically, to develop a control device, it will require research and development (R&D) people to pay great effort to understand corresponding software and hardware knowledge, tools for development, and complicated programming development. Currently, the development of a control device essentially includes the stages of:

(1) understanding the hardware structure of the control device and corresponding functions;

(2) being familiar with the control instruction set of the control device;

(3) being familiar with using development tool software;

(4) designing the system structure of the control device, including the hardware structure and the software implement;

(5) implementing the hardware structure and coding its application programs; and

(6) testing the system design.

However, such a development process obviously has the disadvantages as follows:

(1) the development persons have to be familiar with corresponding software and hardware knowledge;

(2) the programming process is more complicated, and the program is hard to be expanded;

(3) the development persons require understanding the program instructions, the hardware structure and firmware development detail before a produce is developed, which relatively increases the developing period and cost, delays the marketing time of the product, and paying high price to the product quality.

To overcome this problem, U.S. Pat. No. 5,867,818 granted to Lam for a “Programmable sound synthesizer apparatus” has developed a sound synthesizer apparatus without using an instruction. Such a way is simple and direct, but there exists the problems as follows:

(1) requiring a specific memory to store I/O states and events respectively, and implementing corresponding addressing circuit;

(2) requiring pre-storing I/O states and trigger conditions set by a user in a memory; and

(3) executing functions of the programmable control device completely depending on the trigger condition of the input terminal to be met.

Accordingly, it is known that existing programming methods and devices cannot adaptively develop complicated and various programmable control devices, which limits the applications of a user. Therefore, it is desirable to provide an improved programmable control device to mitigate and/or obviate the aforementioned problems.

### SUMMARY OF THE INVENTION

The object of the invention is to provide a programmable control device, which can easily implement required control device and can be applied in a design of complicated and various devices.

To achieve the object, a programmable control device is provided the device includes: an input unit, which has at least one input terminal for receiving an input signal; a memory unit including plural feature tables for corresponding functional units, the feature table of each functional unit defining a state of the functional unit and an event to be executed according to the input signal corresponding to the state; an execution unit, which executes the event corresponding to the functional unit triggered by the input signal inputted by the input unit, and thus produces a driving signal, an output signal or both; a monitor unit, which monitors the execution unit executing an event in order to trigger a corresponding next functional unit when the execution unit produces a driving signal and to use the driving signal as the input signal for the next functional unit to accordingly execute the event with the execution unit; and an output unit, which has at least one terminal to output the output signal.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a programmable control device according to the invention;

FIG. 2 shows feature table examples of functional units of FIG. 1 according to the invention;

FIG. 3 is a graph of an execution of events of FIG. 1 according to the invention;

FIG. 4 is an implement of a video playback device according to the invention; and

FIG. 5 is an implement of a remote dazzling-effect control device.

### DETAILED DESCRIPTION OF THE PREFERRED EMBODIMENT

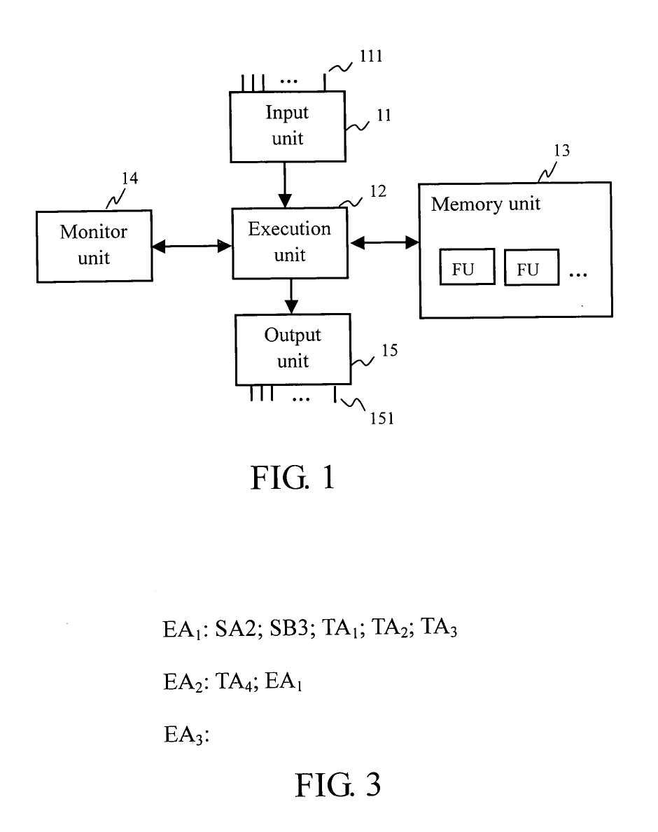

FIG. 1 is a block diagram of a programmable control device according to the invention. In FIG. 1, the programmable control device includes an input unit 11, an execution unit 12, a memory unit 13, a monitor unit 14 and an output unit 15. The input unit 11 has one or more input terminals 111, which can be certain integrated circuit (IC) pins of a control device, for example. The output unit 15 has one or more output terminals 151, which can also be certain IC pins of the control device. The input terminals 111 and the output terminals 151 can be integrated into the input and output terminals.

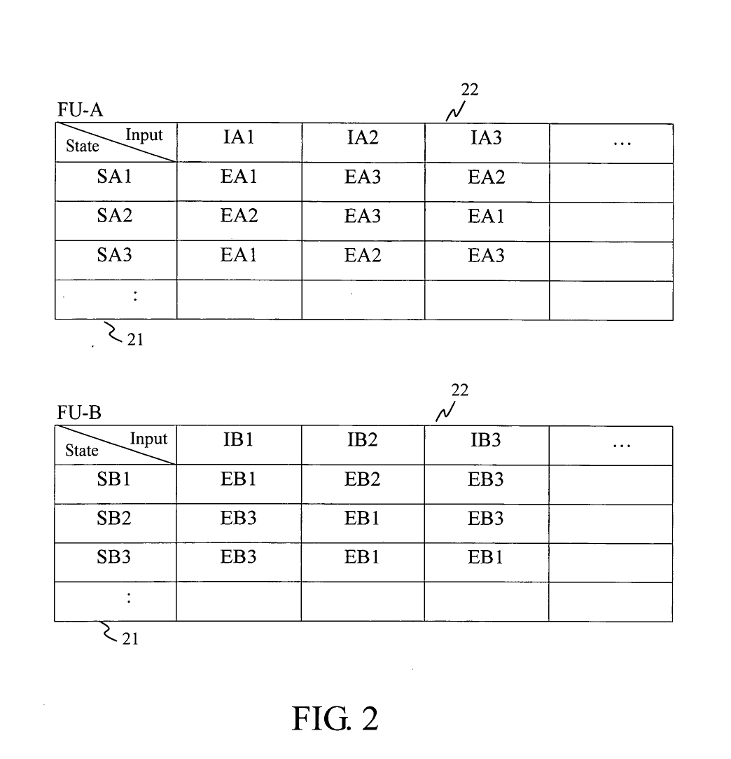

A number of functional units FU containing their feature tables are defined in the memory unit 13. Each functional unit FU represents functions, such as keyboard control, infrared control, sound synthesis, music playback, video control, timer, sensor, and the like, provided by the control device to be developed. Accordingly, the feature table of each functional unit FU defines a state of the functional unit and an event to be executed in the state according to an input signal. FIG. 2 shows examples of two functional units FU-A and FU-B that are defined in the memory unit 13. As shown in FIG. 2, the feature table of the functional unit FU-A is given as a description example, which has a first coordinate 21 to indicate states SAi (i=1˜n) and a second coordinate 22 to indicate IAj (j=1˜m). Accordingly, the (i,j)-th element of the feature table represents an event EA to be executed when the functional unit FU-A is in the state SAi and input signal is IAj. Further, each event EA can be a sequence of tasks in any number. A task can be a state transfer of a functional unit or an event. Thus, the functional unit FU-A executing an event can be: a state transfer of the functional unit FU-A, a state transfer of another functional unit, executing a task, executing another task, or a null (not to execute any state transfer, task and event). In addition, when the execution unit 12 executes a task or an event, it produces an output signal or a driving signal. As shown in FIG. 3, the execution of the event EA₁ includes that the state of the functional unit FU-A is transferred to state SA2, the state of the functional unit FU-B is transferred to state SB3, and tasks TA₁, TA₂, TA₃ are executed. The execution of the event EA₂ includes the execution of task TA₄ and another event EA₁. The event EA₃ executes a null, which indicates that the functional unit FU-A has no action with respect to the input signal.

Referring again to FIG. 1, the execution unit 12 executes an event corresponding to a current state of the functional unit FU triggered by an input signal inputted by the input unit 11, thereby producing a driving signal and/or an output signal. The output signal is outputted by the output unit 15. The driving signal is used to trigger the functional unit FU or another functional unit FU.

The monitor unit 14 monitors the execution unit 12 executing an event in order to trigger a corresponding functional unit FU when the execution unit 12 produces a driving signal, and to use the driving signal as an input signal for the functional unit FU to accordingly execute a corresponding event by the execution unit 12.

Referring again to FIGS. 2 and 3, when an input terminal (such as IA₁) of the input device 11 has an input signal and the functional unit FU-A is in the state SA1, the execution unit 12 executes the event EA1 according to the feature table of the functional unit FU-A. The execution of the event EA1 includes that the state of the functional unit FU-A is transferred to the state SA2, the state of the functional unit FU-B is transferred to the state SB3, and the tasks TA₁, TA₂, TA₃ are executed. The execution of the tasks TA₁, TA₂, TA₃ produces the respective output signals to be outputted by the output signal 15. In addition, the execution of the task TA₃ produces a corresponding driving signal for the functional unit FU-B. At this point, the monitor unit 14 detects the corresponding driving signal and accordingly triggers the functional unit FU-B, and uses the corresponding driving signal as an input signal for the functional unit FU-B. Accordingly, the execution unit 12 can execute an event corresponding to the functional unit FU-B. For example, if the driving signal is inputted to be an input signal IB2 defined by the functional unit FU-B and the functional unit FU-B is in a state SB3, the execution unit 12 subsequently executes the event EB1 according to the feature table of the functional unit FU-B.

A video playback device is given as a design example, which has functional units FU-A and FU-B. The functional unit FU-A is a keys unit having key signals of Play, Stop, Pause/Resume, Forward and Backward. The functional unit FU-B is a timer unit. The execution unit 12 is provided with video play, stop, forward and backward functions. The video playback device is operated by the following rules:

The device starts to play a video when the Play signal is received;

Each video playing has a limited time;

The video playing is stopped when the Stop signal is received;

The video playing is stopped when the Pause/Resume signal is received, but restarted when the Pause/Resume signal is received again;

The video is playing quickly when the Forward signal is received;

The video is playing back when the Backward signal is received;

The Forward and Backward signals can be available only when the video is playing;

The Play signal received does not work when the video is playing; and

The Stop, Pause, Forward, Backward signals are invalid when the video is not playing.

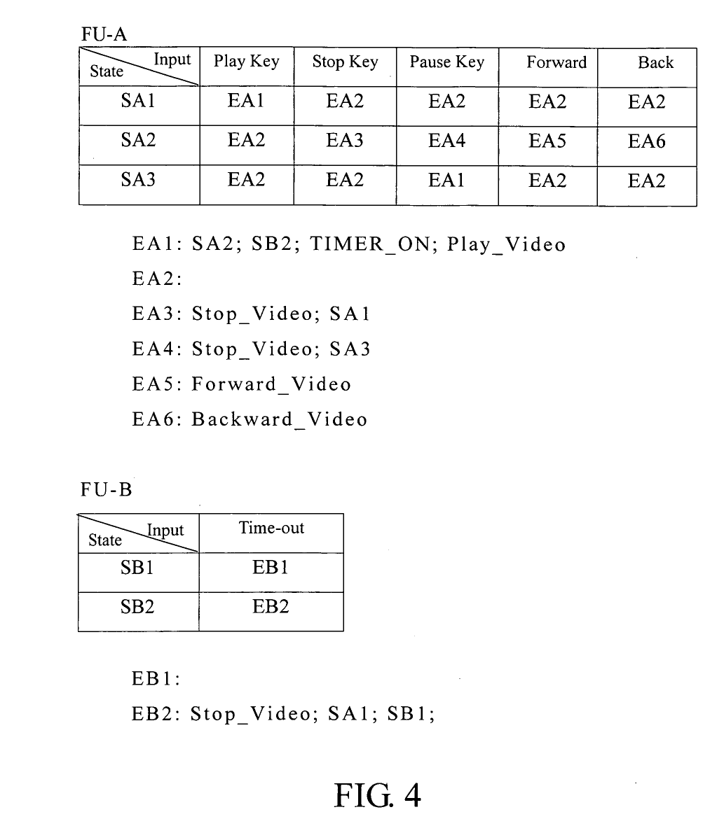

Accordingly, as shown in FIG. 4, the feature tables of the functional units FU-A and FU-B are easily configured, and the events EA1-EA6 and EB1-EB2 to be executed are defined. Thus, the video playback device is implemented.

Further, a remote dazzling-effect control device capable of receiving infrared command to play music and also turning LEDs on and off in a pre-arranged sequence can be designed. The remote dazzling-effect control device is provided with an infrared functional unit FU-A and an LED functional unit FU-B. The execution unit 12 is provided with the capability of audio playback. When the execution unit 12 is playing an audio, the monitor unit 14 picks a tag, in this case, TAG1, TAG2, TAG3 or TAG4 pre-embedded in the music and sends a feedback signal to the execution unit 12. The remote dazzling-effect control device is operated by the following rules:

The functional unit FU-A can receive three commands, including Command_1 as “Play mode on/off”, Command_2 as “Combination 1 to be played”, and Command_3 as “Combination 2 to be played”;

After the “Play mode on/off” command is received, the control device enters a play mode;

The “Combination 1 to be played” and “Combination 2 to be played” commands are valid only when the control device is in the play mode;

After the play mode is entered, the control device leaves the play mode after receiving the “Play mode on/off” command again;

When the “Combination 1 to be played” command is executed, Music 1 is played, and the LEDs are turned on and off in a pre-arranged sequence;

When the “Combination 2 to be played” command is executed, Music 2 is played, and the LEDs are turned on and off in a pre-arranged sequence;

Music 2 is played after Music 1 is complete; and

The control device leaves the play mode after Music 2 is complete.

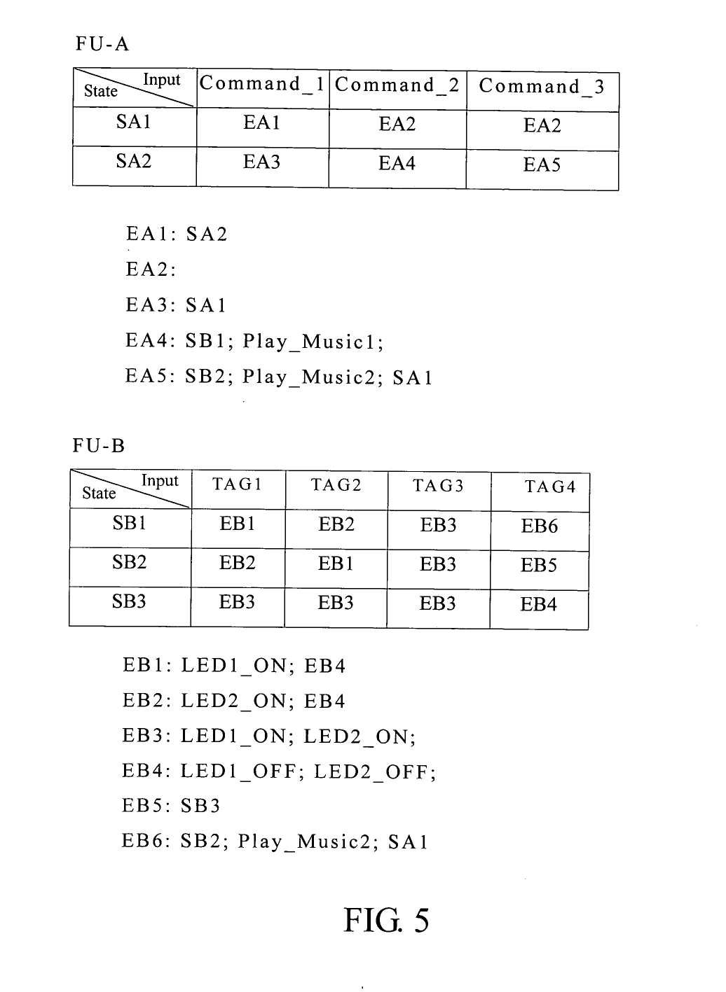

Accordingly, as shown in FIG. 5, the feature tables of the functional units FU-A and FU-B are easily configured, and the events EA1-EAS and EB1-EB6 to be executed are defined. Thus, the remote dazzling-effect control device is implemented.

In view of the foregoing, it is known that the programmable control device in accordance with the present invention can select the functional units and easily configure the feature tables of the functional units selected as required, thereby implementing the desired control device. In addition to the input signals, the functional units can be triggered by the driving signals produced by the execution unit so as to cause a series of operations to be executed. Accordingly, the invention can be applied in the design of complicated and various devices, such as input/output, keyboard, infrared transceiver, timer/counter, sensor, audio and video, and the like.

Although the present invention has been explained in relation to its preferred embodiment, it is to be understood that many other possible modifications and variations can be made without departing from the spirit and scope of the invention as hereinafter claimed.

What is claimed is:

1. A programmable control device, comprising:
an input unit, which has at least one input terminal for receiving an input signal;
a memory unit, including plural feature tables for corresponding functional units, the feature table of each functional unit defining a state of the functional unit and an event to be executed according to the input signal corresponding to the state;
an execution unit, which executes the event corresponding to the functional unit triggered by the input signal inputted by the input unit, and thus produces a driving signal, an output signal or both;
a monitor unit, which monitors the execution unit executing an event in order to trigger a corresponding next functional unit when the execution unit produces a driving signal and to use the driving signal as the input signal for the next functional unit to accordingly execute the event with the execution unit; and
an output unit, which has at least one terminal to output the output signal.

2. The device as claimed in claim 1, wherein the input terminal of the input unit and the output terminal of the output unit are pins of an integrated circuit (IC) chip.

3. The device as claimed in claim 1, wherein a functional unit defined by the memory unit is selectively to be keyboard control, infrared control, speech synthesis, music playback, video control, timer, counter and sensor.

4. The device as claimed in claim 1, wherein the respective event comprises at least one task.

5. The device as claimed in claim 4, wherein the task is a state transfer of a functional unit or an event.
